(19) United States
(12) Patent Application Publication
(10) Pub. No.: US 2025/0296124 A1
(43) Pub. Date: Sep. 25, 2025

(54) FLEXIBLE STEAM CLEANER HEAD AND METHODS

(71) Applicant: CHRIS MATHEWS, MARQUETTE, MI (US)

(72) Inventor: CHRIS MATHEWS, MARQUETTE, MI (US)

(21) Appl. No.: 19/231,878

(22) Filed: Jun. 9, 2025

Related U.S. Application Data
(63) Continuation of application No. PCT/US24/37950, filed on Jul. 13, 2024.
(60) Provisional application No. 63/527,510, filed on Jul. 18, 2023.

(51) Int. Cl. B08B 3/10; B08B 1/14

(52) U.S. Cl. CPC B08B 3/10; B08B 1/143; B08B 2203/007; B08B 2230/01

(57) ABSTRACT

A flexible steam cleaner head for cleaning the surface of logs. The cleaner head comprises a substantially plate shaped base with a stem extending perpendicular from a proximal surface of the base. A first wing and a second wing are pivotably attached to the base on opposed sides of the base and can be biased centrally. The stem comprises a stem cannula extending along a central axis of the stem to carry steam from the proximal end of the stem to the base. A plurality of base channels extend through the base to deliver steam to the distal face of the base for contact with the log. A plurality of wing channels carry steam from the base into the wings where it exits from a wing steam face also for contact with the log. The distal end of the steam cleaner head can be covered with a cleaning pad.

### CROSS REFERENCE TO RELATED APPLICATIONS

This Application is a Continuing U.S. Non-Provisional Patent Application that claims priority to International Patent Application No. PCT/US24/37950 filed Jul. 13, 2024 which claims the benefit of U.S. Provisional Patent Application No. 63/527,510 filed Jul. 18, 2023, the entire disclosures of which are hereby incorporated by reference and relied upon.

### BACKGROUND OF THE INVENTION

Field of the Invention. The invention relates generally to the use of steam generators to clean surfaces, and more particularly to flexible steam cleaner heads attachable to a steam generator for cleaning curved surfaces such as logs.

Description of Related Art. Cleaning curved surfaces can be difficult since a vast majority of cleaning supplies such as mops and brushes are directed towards the cleaning of flat surfaces. Log homes for example, are constructed of logs that typically have a convex surface. Surfaces such as these are challenging to clean since the prior art lacks good cleaning tools for use on these surfaces.

What is needed are cleaning tools adapted to clean curved surfaces to reduce the physical demands of cleaning these surfaces while simultaneously improving the cleaning effectiveness of cleaning curved surfaces such as logs in log homes.

### SUMMARY OF THE INVENTION

Disclosed herein is a flexible steam cleaner head for use with a steam generator such as a steam cleaner. The flexible steam cleaner head is designed to deliver steam and cleaning pad contact across a curved surface for ergonomic, thorough and efficient cleaning.

In one form, a flexible steam head is coupled to a steam tube extending from a steam generator.

In one form, a flexible steam head covered with a cleaning pad comprises a cleaning face (engagement face) which is used for physically contacting a curved face structure such as a log to be cleaned.

In one form, the steam tube comprises one or more delivery port faces that define a delivery port at the distal end of the steam tube.

In one form, the delivery port faces form an octagonal shaped delivery port.

In one form, the distal end of the steam tube terminates at an end face that extends between the outside face of the steam tube and the delivery port faces.

In one form, the steam tube comprises a lock operable for locking the steam tube to the stem of the flexible steam cleaner head.

In one form, a flexible steam cleaner head comprises a base with a stem extending from the base.

In one form, the base and stem are configured as a ‘T’.

In one form, the base is in the form of a curved plate whereas, the stem is in the form of a tube.

In one form, the flexible steam cleaner head comprises a first wing and a second wing which articulate with the base.

In one form, the first wing and second wing are substantially in the form of a curved plate.

In one form, the base is substantially rectangular or square, but can assume other profiles.

In one form, the base comprises a broad base steam face on the distal side spaced from an opposed base proximal face on the proximal side.

In one form, a base end face extends on opposing sides between the base steam face and base proximal face.

In one form, the base steam face is concave.

In one form, a base lateral face defines a pivot boss which extends on two opposing sides from the base end face.

In one form, the pivot boss is defined at terminal ends by a pivot boss end face.

In form, a base step is defined by the pivot boss end face and base end face for receiving a pivot arm of a first wing or second wing.

In one form, the pivot bosses comprise a boss pivot face defining elongate pivot apertures extending from one pivot boss end face to the other pivot boss end face on each pivot boss.

In one form, the pivot apertures have threads for receiving pivot struts in the form of a threaded screw having an enlarged pivot head with a drive socket within the pivot head.

In one form, the pivot struts are in the form of unthreaded pins which can be pressed in the pivot apertures.

In one form, raised between the base proximal face and the base lateral face on each pivot boss is a boss stop operable to limit range of motion of the respective first wing or second wing.

In one form, the boss stop is elongate and parallel to the pivot aperture.

In one form, the base comprises one or more base side portals extending through the base lateral face which opens to a channel face that defines base channels traversing to the center of the base to a respective wing intake portal which extends into the base through the base proximal face. This base side portal-base channel-wing intake portal provides a passageway for steam to travel from the steam generator to wing exit portals on the respective first wing or second wing.

In one form, the base comprises a base bottom portal extending through the base steam face and which opens to a channel face that defines base channels that traverse to the center of the base to a respective base intake portal which extends into the base through the base proximal face. The base bottom portals-base channel-base intake portal provides a passageway for steam to travel from the steam generator to the base steam face.

In one form, the base bottom portals and the wing exit portals have channel flares to broaden their connection with the respective wing steam face and base steam face.

In one form, the stem extends substantially perpendicular to the base from the base proximal face.

In one form, the stem is in the form of a tube having a stem wall with a stem inner face defining a stem cannula that extends from the base proximal face to a stem end face.

In one form, the stem wall comprises a stem outer face which is configured for sliding engagement within a delivery port of a steam tube. For example, the stem wall can define an octagonal interface that complements the delivery port, however, other shape profiles can be used.

In one form, the proximal end of the stem comprises a stem lock operable for locking and releasing the flexible steam cleaner head from the steam tube.

In one form, the stem lock comprises a stem lock recess inset in the stem wall and parallel to the stem axis C.

In one form, the stem lock comprises a lock aperture extending through the stem wall.

In one form, the stem lock comprises a lock tooth for engaging a portion of a lock on the steam tube.

In one form, a cleaning pad is secured against the base steam face and/or the wing steam face.

In one form, a plurality of capture prongs extend from the base steam face and/or wing steam face wherein the capture prongs are configured for releasable fixation to the cleaning pad.

In one form, the cleaning pad comprises a cleaning face configured to face the surface to be cleaned, a back face configured to rest against the base steam face and the wing steam face, and an edge face extending between the cleaning face and back face.

In one form, the cleaning pad comprises a capture wall extending from the periphery of the cleaning pad such that the cleaning pad is secured to the flexible steam cleaner head much like a fitted sheet secures to a mattress.

In one form, extending from the stem outer surface is an alignment rib to assist with alignment with a complementary structure on the steam tube. The alignment rib is positioned generally parallel to stem axis C.

In one form, the first wing and second wing are duplicates of each other.

In one form, the first wing is pivotably secured to one pivot boss and the second wing is pivotably secured to the remaining pivot boss.

In one form, the wings are substantially square or rectangular having a broad wing proximal face spaced from a broad wing steam face.

In one form, a wing end face extends between the wing proximal face and wing steam face on the lateral side of the wings.

In one form, a wing edge face extends between wing steam face and wing proximal face on a side opposite the pivot arms.

In one form, a pair of spaced wing end faces extend between the wing proximal face and wing steam face on opposed sides of the wings.

In one form, a pivot boss recess face defining a pivot boss recess extends into the remaining side of the wings and defines a pair of pivot arms extending from each wing end face.

In one form, each pivot arm is defined by a substantially flat inner arm face which faces the opposing inner arm face.

In one form, the pivot arms comprise a pivot strut recess face defining a pivot strut recess. The pivot strut recesses are aligned along the respective pivot axis A and pivot axis B.

In one form, pivot head recess faces extend from the opposing wing end faces to form a pivot head recess for housing a pivot head (i.e. a screw head) therein. The pivot head recess is aligned with the pivot strut recess.

In one form, a gasket recess face extends into the pivot boss recess face to define a gasket recess which is configured to house a wing gasket therein.

In one form, the wing gasket is in the form of a flexible tube.

In one form, a stop block extends along one side of the pivot boss recess to limit rotation of the respective wing.

In one form, a wing receiver portal opens from the gasket recess to join with the channel faces that form the wings channels. The wing channels extend through the respective wings until coupling with the wing exit portals.

In one form, the wing gasket serves to transmit steam that has traveled from the steam tube, down the stem cannula, into the wing intake portal, through the base channels, to the base side portals, into the wing gasket, into the wing receiver portal, into the wing channels, before finally exiting the wing exit portals.

In one form, a pivot boss is seated within the pivot boss recess of a first wing with the respective pivot axis aligning the pivot strut recess and pivot aperture.

In one form, a pivot boss is seated within the pivot boss recess of a second wing with the respective pivot axis aligning the pivot strut recess and pivot aperture.

In one form, a torsion spring having a pair of spring arms and a central spring aperture is aligned and positioned between the pivot boss end faces of the base, and the inner arm faces of the wings.

In one form, the spring arms are positioned such that the torsion springs cause bias of the wings towards each other to a position whereby the wings are positioned substantially 90+ degrees from the base.

In one form, the wings can be moved against spring force to a position whereby the base steam face and the wing steam faces are substantially planar.

In one form, a plurality of pivot struts in the form of a screw are extended through the pivot strut recess, the spring aperture, and are threaded into the aligned pivot aperture.

In one form, the stop block and boss stop collide thereby preventing further wing pivoting motion.

In one form, the concave curvature of the engagement faces can be varied for fit to various sized logs or other curved surfaces.

In one form, the base, the first wing, and the second wing are substantially solid with the channel structure formed therein such as by additive manufacturing. In alternative embodiments, the flexible steam cleaner head can be formed by an assembly of parts with hoses extending between the various portals.

In one form, the base, the first wing, and the second wing, are manufactured from a polymer.

In one form, use of a flexible steam cleaner head comprises the following steps. Obtaining a steam generator with a steam tube (200), and a flexible steam cleaner head (202) as described herein. Aligning the stem of the flexible steam cleaning head with the steam tube of a steam generator. Sliding the stem into the delivery port of the steam tube until locking engagement occurs (204). Coupling a cleaning pad to one or both of a wing steam face and base steam face of the flexible steam cleaner head (206). Turning on the steam generator (208) to drive steam to the stem cannula of the flexible steam cleaner head and to push the steam through portals and wing channels and base channels for delivery of the steam at the wing steam face and base steam face. Applying cleaning solutions to the cleaning pad if desired (210). Positioning the flexible steam cleaner head such that the cleaning face of the cleaning pad compresses against the elongate curved surface to be cleaned (212) adding sufficient force to expand the wings outward to assure full contact. Moving the flexible steam cleaner head along the elongate axis of the curved surface until the curved surfaces are clean (214).

### BRIEF DESCRIPTION OF THE SEVERAL VIEWS OF THE DRAWINGS

These and other features and advantages of the present invention will become more readily appreciated when considered in connection with the following detailed description and appended drawings, wherein each drawing is according to one or more embodiments shown and described herein, and wherein:

FIG. 1 depicts a perspective view of a flexible steam cleaner head in preparation for coupling with a steam generator;

FIG. 2 depicts a perspective view of the flexible steam cleaner head of FIG. 1 in preparation for cleaning a log;

FIG. 3 depicts a perspective view of the flexible steam cleaner head of FIG. 1 being moved along axis D of a log as it delivers steam to clean the log's curved outer surface;

FIG. 4 depicts an exploded perspective view of the flexible steam cleaner head of FIG. 1;

FIG. 5 depicts a top perspective view of the base and stem of the flexible steam cleaner head of FIG. 1;

FIG. 6 depicts a side perspective view of the base and stem of the flexible steam cleaner head of FIG. 1;

FIG. 7 depicts a bottom view of the base and stem of the flexible steam cleaner head of FIG. 1;

FIG. 8 depicts a bottom perspective view of the base and stem of the flexible steam cleaner head of FIG. 1;

FIG. 9 depicts a side view of the base and stem of the flexible steam cleaner head of FIG. 1;

FIG. 10 depicts a cross-sectional view of the base of the flexible steam cleaner head of FIG. 1;

FIG. 11 depicts a second cross-sectional view of the base of the flexible steam cleaner head of FIG. 1;

FIG. 12 depicts a side perspective view of a first wing or second wing of the flexible steam cleaner head of FIG. 1;

FIG. 13 depicts a bottom perspective view of a first wing or second wing of the flexible steam cleaner head of FIG. 1;

FIG. 14 depicts a side view of a first wing or second wing of the flexible steam cleaner head of FIG. 1;

FIG. 15 depicts a cross-sectional view of the first wing or second wing depicted in FIG. 14;

FIG. 16 depicts an alternative single axis pivoting junction between a steam tube from a steam generator and a flexible steam cleaner head;

FIG. 17 depicts a cross sectional view of the stem and a motion coupler parts of a flexible steam cleaner head;

FIG. 18 depicts an alternative multi-axis pivoting junction between a steam tube from a steam generator;

FIG. 19 depicts an internal view of one half of the coupler in the multi-axis pivoting junction of FIG. 18;

FIG. 20 depicts a perspective view of the pivoting coupler element of the multi-axis pivoting junction of FIG. 18;

FIG. 21 depicts a graphic describing the steps to cleaning an elongate curved surface using a flexible steam cleaner head.

### DETAILED DESCRIPTION OF SELECTED EMBODIMENTS OF THE INVENTION

Select embodiments of the invention will now be described with reference to the Figures. Like numerals indicate like or corresponding elements throughout the several views and wherein various embodiments are separated by letters (i.e. 100, 100B, 100C). The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

Depicted in the Figures is an embodiment of a flexible steam cleaner head for use with a steam generator such as a steam cleaner. The flexible steam cleaner head is designed to deliver steam and cleaning pad contact across a curved surface for ergonomic, thorough, and efficient cleaning.

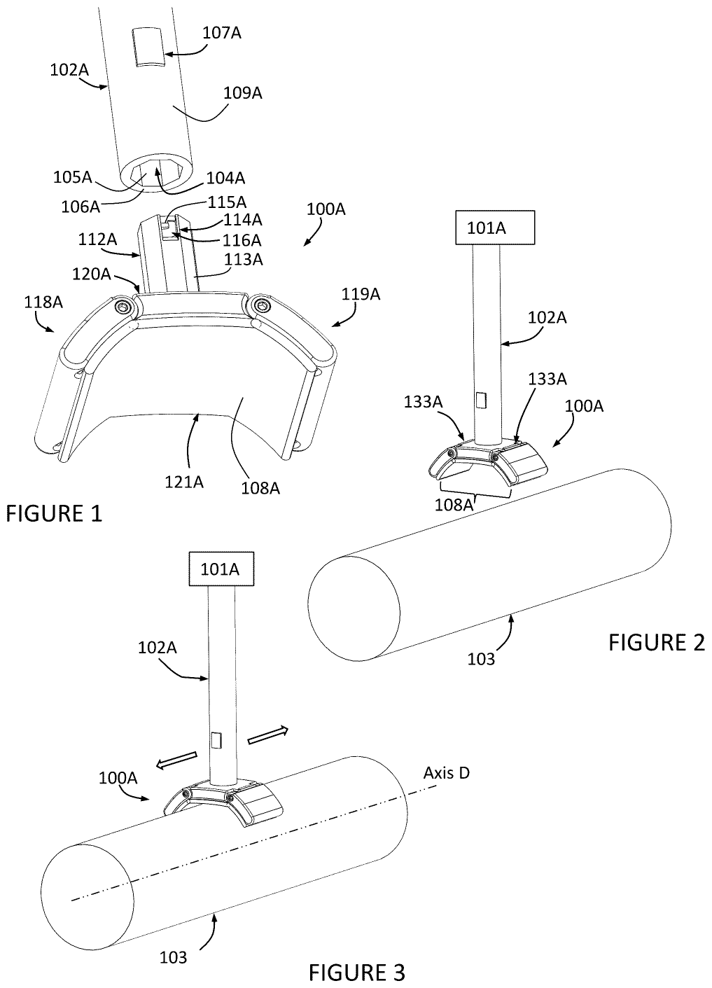

In a preferred embodiment, FIG. 1 depicts a flexible steam cleaner head 100A coupled to a steam tube 102A extending from a steam generator 101A. In this embodiment, the flexible steam cleaner head 100A is covered with a cleaning pad 121A at a distal end. The cleaning pad comprises an engagement face 108A which is used for physically contacting a curved face structure 103 such as a log to be cleaned. The cleaning pad can be in any variety of forms found in the prior art such as for example, a cloth, a sponge, or a scrub pad (i.e. 3M Scotch-Brite® brand scouring pad).

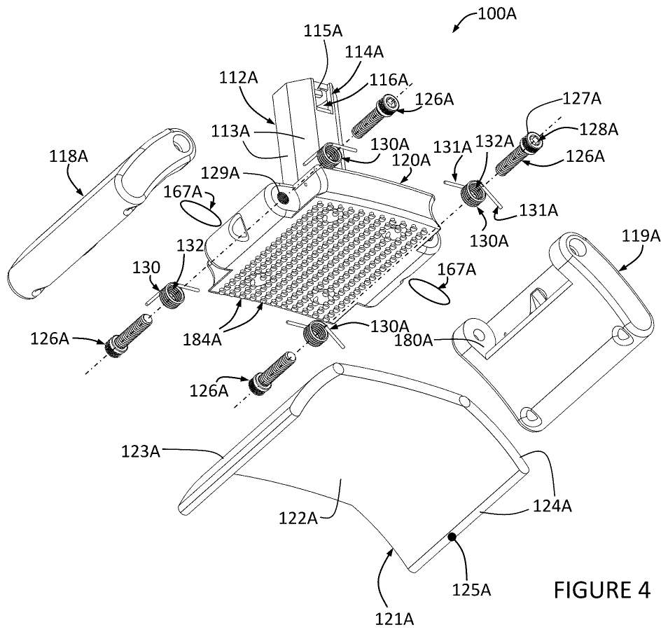

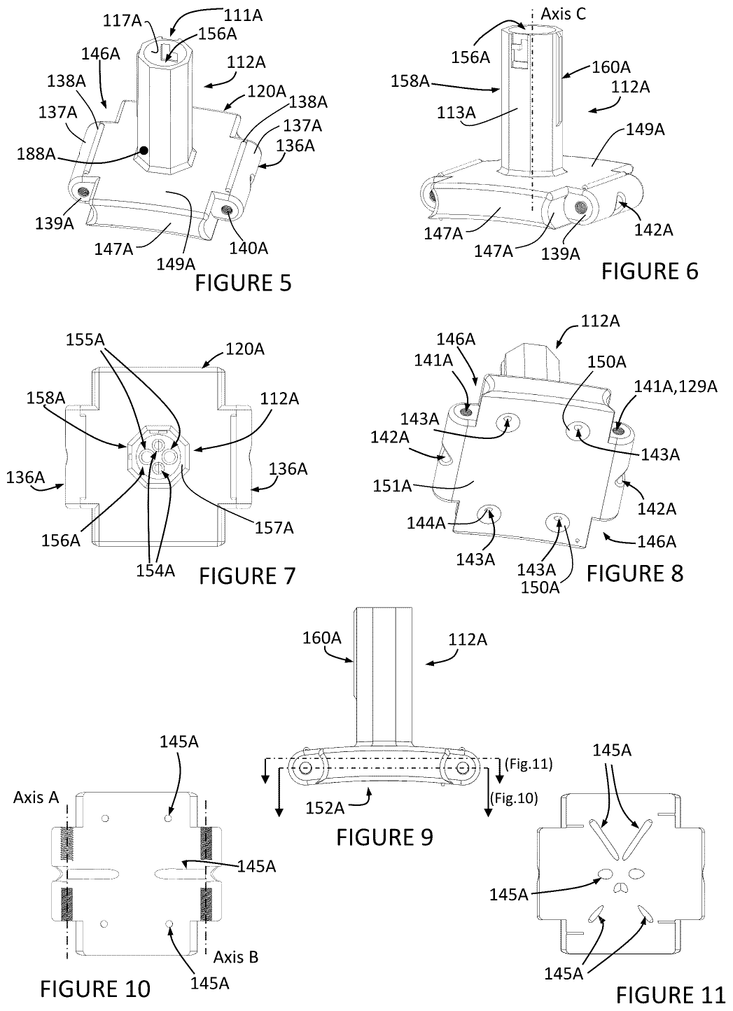

The steam tube 102A comprises one or more delivery port faces 105A that define a delivery port 104A at the distal end of the steam tube. The delivery port faces 105A form an octagonal shaped delivery port 104A in this embodiment, but other configurations for the delivery port such as a hexagon can be used to complement attachment to the flexible steam head. The distal end of the steam tube 102A terminates at an end face 106A that extends between the outside face 109A of the steam tube and the delivery port faces 105A. The steam tube 102A comprises a lock 107A operable for locking the steam tube 102A to the stem 112A of the flexible steam cleaner head 100A. A flexible steam cleaner head 100A comprises a base 120A with a stem 112A extending from the base as further depicted in FIGS. 4-11. As depicted in FIG. 5, the stem 112A can rigidly extend from the base forming a ‘T’ between the stem and the base. In other embodiments however, a motion coupler (i.e. 188B, 188C) is integrated into or coupled to the stem providing the steam head the ability to move in relation to the stem anywhere in a single plane in some embodiments, or within multiple planes in other embodiments. In some cases, the motion coupler will allow the steam head to rotate about an axis while still delivering steam.

The flexible steam cleaner head 100A comprises a first wing 118A and a second wing 119A which articulate with the base 120A. In this embodiment, this articulation is in the form of a hinge 133A between the base and wings although other forms of articulation can be utilized. The base 120A is substantially rectangular or square, but can assume other profiles and further comprises a broad base steam face 151A spaced from an opposed base proximal face 149A. A base end face 147A extends on opposing sides between the base steam face 151A and base proximal face 149A. It is preferred that the base steam face 151A is concave 152A to match or approximate the curvature of the face to be cleaned. A base lateral face 137A defines a pivot boss 136A which extends on two opposing sides from the base end face 147A. The pivot boss 136A is defined at terminal ends by a pivot boss end face 139A. A base step 146A is defined by the pivot boss end face 139A and base end face 147A for receiving a pivot arm 169A of a first wing 118A or second wing 119A. Those skilled in the art will recognize that in alternative embodiments that the pivot arms and pivot bosses can be swapped wherein the pivot boss is on the wing and the pivot arm extends from the base to effectively form a hinge therebetween.

The pivot bosses 136A comprise a boss pivot face 140A defining elongate pivot apertures 141A extending from one pivot boss end face 139A to the other pivot boss end face on each pivot boss 136A. The pivot apertures 141A can have threads 129A for receiving pivot struts 126A in the form of a threaded screw having an enlarged pivot head 127A with a drive socket 128A within the pivot head (FIG. 4) for advancing with a drive tool. Alternatively, the pivot struts 126A are in the form of unthreaded pins which can be pressed in the pivot apertures 141A.

Raised between the base proximal face 149A and the base lateral face 137A on each pivot boss 136A is a boss stop 138A operable to limit range of motion of the respective first wing or second wing. In this embodiment, the boss stop is elongate and parallel to the pivot aperture but can be in other forms such as a dome shaped bump.

As noted in FIG. 8, base 120A comprises one or more base side portals 142A extending through the base lateral face 137A which opens to a channel face 144A that defines base channels 145A traversing to the center of the base 120A to a respective wing intake portal 155A which extends into the base through the base proximal face 149A. This base side portal-base channel-wing intake portal provides a passageway for steam to travel from the steam generator 101A to wing exit portals 165A on the respective first wing 118A or second wing 119A. FIGS. 9-11 depict cross-sections of the base to illustrate the channels traversing between various portals. The base 120A comprises a base bottom portal 143A extending through the base steam face 151A and which opens to a channel face 144A that defines base channels 145A. These base channels traverse to the center of the base 120A to a respective base intake portal 154A which extends into the base through the base proximal face 149A. The base bottom portals-base channel-base intake portal provides a passageway for steam to travel from the steam generator 101A to the base steam face. The base bottom portals 143A and the wing exit portals 165A have channel flares 150A to broaden their connection with the respective wing steam face 164A and base steam face 151A.

As noted in the Figures, stem 112A extends substantially perpendicular to the base from the base proximal face 149A to form a ‘T’ shaped arrangement. The stem is in the form of a tube having a stem wall 158A with a stem inner face 117A defining a stem cannula 156A that extends from the base proximal face 149A to a stem end face 157A. The stem wall 158A comprises a stem outer face 113A which is configured for sliding engagement within delivery port 104A of steam tube 102A. For example, the stem wall can define an octagonal interface that complements the delivery port. The proximal end of the stem 112A comprises a stem lock 114A operable for locking and releasing the flexible steam cleaner head 100A from the steam tube 102A.

Stem lock 114A (FIGS. 5-7) comprises a lock recess 111A inset in stem wall 158A and parallel to the stem axis C. The stem lock comprises a lock aperture 116A (FIG. 4) extending through the stem wall and a lock tooth 115A for engaging a portion of a lock 107A on the steam tube. A cleaning pad 121A is secured against the base steam face and/or the wing steam faces 164A. A plurality of capture prongs 184A extend from the base steam face 151A (and/or wing steam faces 164A in alternative embodiments) wherein the capture prongs 184A are configured for releasable fixation to the cleaning pad 121A (i.e. Velcro). The cleaning pad 121A comprises a cleaning face 122A configured to face the surface to be cleaned, a back face 123 configured to rest against the base steam face 151A and the wing steam faces 164A, and an edge face 124A extending between the cleaning face and back face. In alternative embodiments, the cleaning pad 121A comprises a capture wall 125A extending from the periphery of the cleaning pad such that the cleaning pad is secured to the flexible steam cleaner head 100A much like a fitted sheet secures to a mattress.

As noted in FIG. 6, extending from the stem outer face 113A is one or more alignment rib 160A to assist with alignment with a complementary structure on the steam tube 102A. The alignment rib 160A is generally parallel to stem axis C.

As can be observed from FIG. 4, first wing 118A and second wing 119A are duplicates of each other in some embodiments. In other embodiments, they are not duplicates. The first wing 118A is pivotably secured to one pivot boss 136A and the second wing 119A is pivotably secured to the remaining pivot boss 136A. The wings (first wing 118A and second wing 119A) are substantially square or rectangular having a broad wing proximal face 175A spaced from a broad wing steam face 164A. Wing end face 170A extends between the wing proximal face 175A and wing steam face 164A on the lateral side of the wings. A wing edge face 168A extends between wing steam face 164A and wing proximal face 175A on a side opposite the pivot arms. A pair of spaced wing end faces 170A extend between the wing proximal face 175A and wing steam face 164A on opposed sides of the wings.

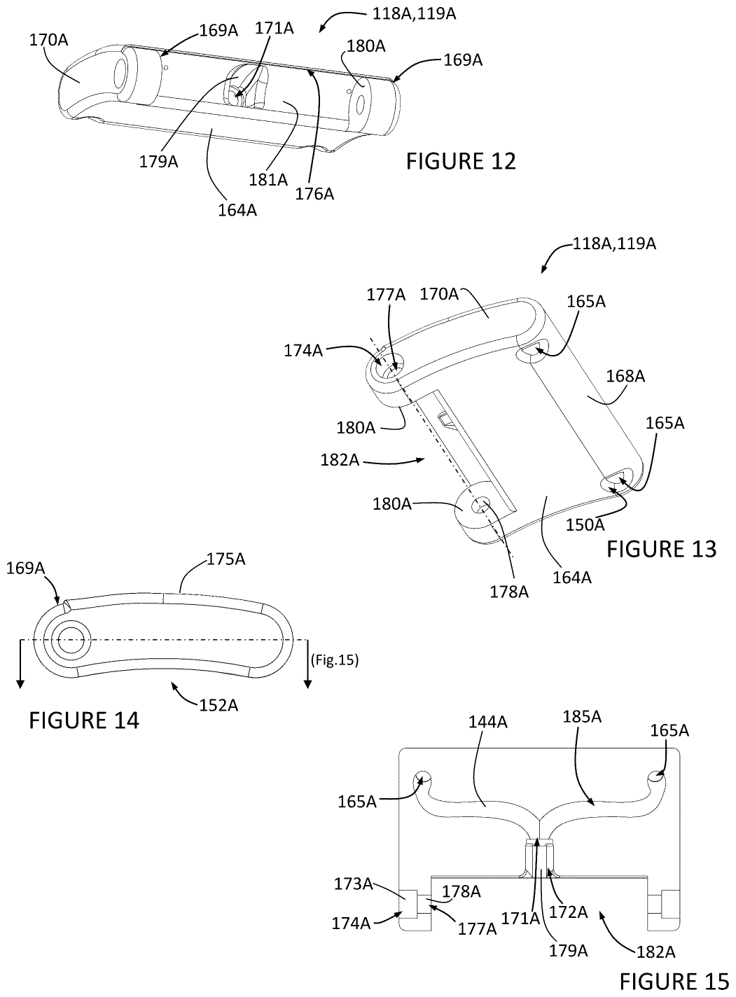

Depicted in FIG. 12, a pivot boss recess face 181A defining a pivot boss recess 182A extends into the remaining side of the wings and defines a pair of pivot arms 169A extending from each wing end face 170A. Each pivot arm 169A is defined by a substantially flat inner arm face 180A which faces the opposing inner arm face 180A. The pivot arms 169A comprise a pivot strut recess face 178A defining a pivot strut recess 177A. The pivot strut recesses are aligned along the respective pivot axis A and pivot axis B. Pivot head recess faces 173A extend from the opposing wing end faces 170A to form a pivot head recess 174A for housing a pivot head 127A (i.e. a screw head) therein. The pivot head recess is aligned with the pivot strut recess.

A gasket recess face 179A extends into the pivot boss recess face 181A to define a gasket recess 172A which is configured to house a wing gasket 167A therein. The wing gasket 167A is in the form of a flexible tube or other gasket known in the art. A stop block 176A extends along one side of the pivot boss recess 182A to limit rotation of the respective wing. In some cases this is due to abutting boss stop 138A. A wing receiver portal 171A (FIGS. 12 and 15) opens from the gasket recess 172A to join with the channel faces 144A that form the wing channels 185A. The wing channels extend through the respective wings until coupling with wing exit portals 165A.

Wing gasket 167A serves to transmit steam that has traveled from steam tube 102A, down the stem cannula 156A, into the wing intake portal 155A, through the base channels 145A, to the base side portals 142A, into the wing gasket 167A, into the wing receiver portal 171A, into the wing channels 185A, before finally exiting the wing exit portals 165A.

A pivot boss 136A (FIG. 7) is seated within the pivot boss recess 182A of a first wing 118A with the respective pivot axis aligning the pivot strut recess 177A and pivot aperture 141A. A torsion spring 130A (FIG. 4) having a pair of spring arms 131A and a central spring aperture 132A is aligned and positioned between the pivot boss end faces 139A of the base, and the inner arm faces 180A of the wings. The spring arms 131A are positioned such that the torsion springs 130A cause bias of the wings (wing steam faces) towards each other to a position whereby the wings are positioned substantially 90+ degrees from the base. The wings can be moved against spring force to a position whereby the base steam face 151A and the wing steam faces 164A are substantially planar. As noted in FIG. 4, a plurality of pivot struts 126A in the form of a screw are extended through the pivot strut recess 177A, the spring aperture 132A, and are threaded into the aligned pivot aperture 141A. To control the range of motion of the wings, the stop block 176A and boss stop 138A collide thereby preventing further wing pivoting motion.

It is noted that the concave 152A curvature of the base steam face 151A and wing steam face 164A can be varied if desired for best fit to various sized logs or other curved surfaces.

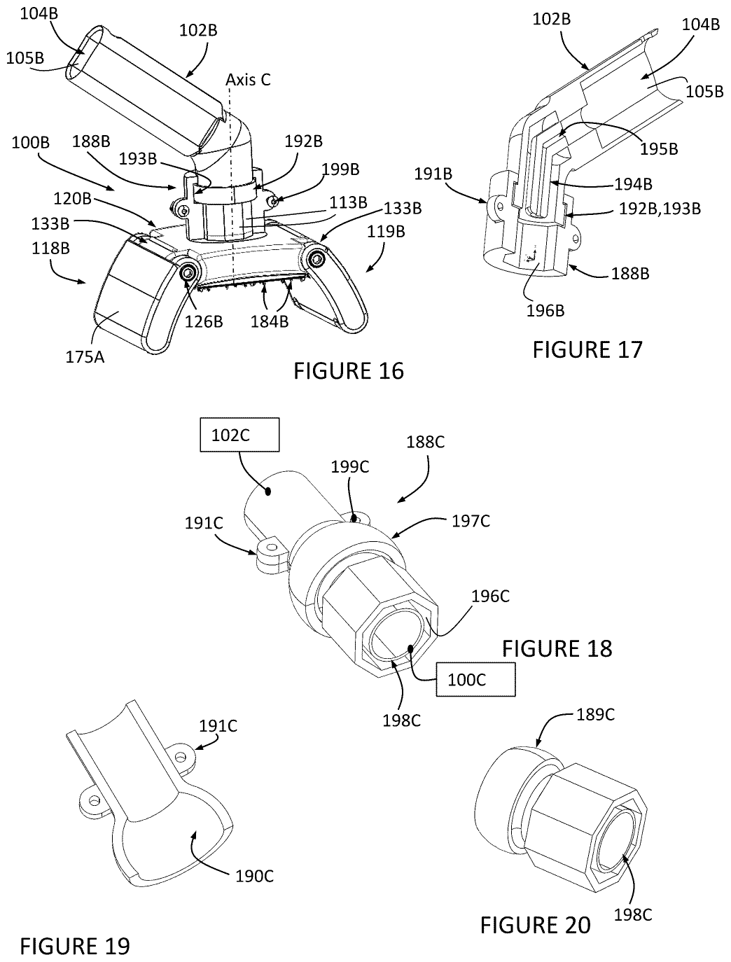

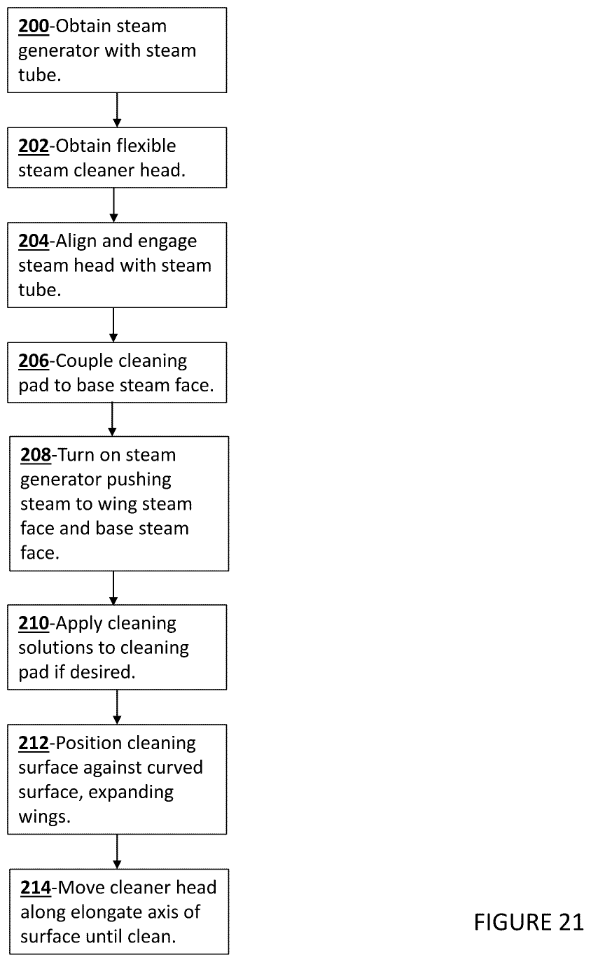

FIGS. 16-17 depict one embodiment of a motion coupler 188B between a steam tube 102B and a flexible steam cleaner head 100B. In this embodiment, the flexible steam cleaner head is configured to pivot about axis C to prevent binding between the steam tube and flexible steam cleaner head. An interlock boss 192B is ring shaped in this embodiment and seats in interlock recess 193B of motion coupler 188B to provide single axis pivoting. In some embodiments, extending distally down the center of steam tube 102B is reduced steam tube 194B having steam aperture 195 extending therethrough. Central faces 196B engage with stem outer faces 113B.

FIGS. 18-20 depicts an embodiment of a multi-axis motion coupler 188C between a steam tube 102C and a flexible steam cleaner head 100C. In this embodiment, the two assemblies are coupled by an intermediate ball and socket joint 197C which provides for pivoting motions along multiple axes between the steam tube and flexible steam cleaner head thereby preventing any binding from occurring as the flexible steam cleaner head is orientated for positioning over the log to be cleaned. Forming the motion coupler and ball and socket joint is a socket swivel 190C here formed in two halves that are mated and secured together by use of ear fasteners 199C extending through restraining ears 191C. A ball swivel 189C seats in the socket swivel 190C to provide the multi-axis motion. As depicted in FIG. 20, an inner stem lock 198C is configured to mate to the stem of a flexible steam cleaner head. The opposing end of the multi-axis motion coupler 188C is configured to mate to a steam tube 102C.

It is noted that the terms “substantially” and “about” and “generally” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. A flexible steam cleaner head comprising:
a base;
said base in the form of a plate;
said base having a curved base proximal face facing proximally;
said base having a base distal face facing distally;
said base having a one or more base lateral faces facing laterally;
a stem;
said stem extending perpendicular from said base proximal face;
a first wing;
a second wing;
said first wing and said second wing comprising a wing steam face on a distal side of said first wing and said second wing;
said first wing and said second wing pivotably coupled to said base at opposing lateral sides of said base;
said stem having a stem cannula extending along a central axis of said stem operable to carry steam from a proximal end of said stem to said base;
said base comprising a plurality of base channels extending between said base proximal face at said stem cannula and said base distal face;
said base comprising a plurality of base channels extending between said base proximal face at said stem cannula and said base lateral faces; and,
said first wing and said second wing having one or more wing channels operable to carry steam from said base channels to wing exit portals on said wing steam face.

2. The flexible steam cleaner head of claim 1 further comprising:
said base comprising a pair of opposing pivot bosses laterally extending from said base.

3. The flexible steam cleaner head of claim 2 further comprising:
said first wing and said second wing having a pair of spaced pivot arms extending from one side.

4. The flexible steam cleaner head of claim 3 further comprising:
a pivot strut recess;
said pivot strut recess extending through said pair of spaced pivot arms;
a pivot aperture;
said pivot aperture extending through said pivot bosses;
one or more pivot struts;
wherein said pivot strut extends between said pivot strut recess and said pivot aperture.

5. The flexible steam cleaner head of claim 1 further comprising:
one or more torsion springs; and,
wherein said one or more torsion spring bias said first wing and said second wing distally.

6. The flexible steam cleaner head of claim 1 further comprising:
a cleaning pad; and,
a plurality of capture prongs extending from said base steam face for engaging with said cleaning pad.

7. The flexible steam cleaner head of claim 1 further comprising:
a wing gasket;
wherein said wing gasket is positioned between said first wing or second wing and said base to prevent loss of steam therebetween during operation.

8. The flexible steam cleaner head of claim 1 further comprising:
a steam tube operable to deliver steam;
a motion coupler;
said motion coupler configured to provide pivoting about a single axis between said steam tube and said flexible steam cleaner head.

9. The flexible steam cleaner head of claim 1 further comprising:
a motion coupler;
said motion coupler configured to provide multi-axis pivoting between said steam tube and said flexible steam cleaner head.

10. The flexible steam cleaner head of claim 1 wherein said first wing and said second wing splay laterally when engaging a log for cleaning.

11. The flexible steam cleaner head of claim 1 wherein said wing steam face on said first wing and said second wing is concave.

12. The flexible steam cleaner head of claim 1 wherein said base steam face on said base is concave.

13. The flexible steam cleaner head of claim 1 wherein said stem comprises a stem lock recess for locking engagement with a steam tube.

14. The flexible steam cleaner head of claim 1 further comprising:
said stem comprising a stem outer face facing outward;
an alignment rib;
wherein said alignment rib extends from said stem outer face.

15. The flexible steam cleaner head of claim 1 further comprising:
said stem comprising a stem outer face facing outward; and,
wherein said stem outer face is octagonal.

16. The flexible steam cleaner head of claim 1 further comprising:
a cleaning pad; and,
wherein said cleaning pad is sized to cover said base steam face and said wing steam faces.

17. The flexible steam cleaner head of claim 1 further comprising:
a wing exit portal in said steam face;
wherein said first wing and said second wing each have at least two wing exit portals operable to deliver steam.

18. The flexible steam cleaner head of claim 1 further comprising:
a base bottom portal in said base steam face;
wherein said base steam face comprises at least four base bottom portals to deliver steam.

19. A method of cleaning a log comprising:
obtaining a flexible steam cleaner head having a base and a pair of pivotable wings extending from the base, and wherein the wings are biased medially;
coupling the flexible steam cleaner head to a steam tube of a steam generator;
securing a cleaning pad to distal faces of the flexible steam cleaner head;
turning on the steam generator such that steam is delivered to the flexible steam cleaner head;
placing the cleaning pad against the outer surface of a log to be cleaned causing the wings to expand around the surface of the log.

20. The method of cleaning a log of claim 19 further comprising the step of:
moving the flexible steam cleaner head along the surface of the log to clean off debris.
